(19) United States
(12) Patent Application Publication
(10) Pub. No.: US 2023/0166661 A1
(43) Pub. Date: Jun. 1, 2023

(54) METHOD FOR AUTOMATING THE OPERATIONS OF VEHICLE-MOUNTED CAMERA AND VEHICLE-MOUNTED APPARATUS APPLYING THE METHOD

(71) Applicant: Mobile Drive Netherlands B.V., Amsterdam (NL)

(72) Inventor: YU-HUA HUNG, New Taipei (TW)

(21) Appl. No.: 17/993,190

(22) Filed: Nov. 23, 2022

(30) Foreign Application Priority Data
Nov. 26, 2021 (CN) 202111422850.7

(51) Int. Cl. B60R 1/22; G01S 13/86

(52) U.S. Cl. CPC B60R 1/22; G01S 13/867; B60R 2300/301; B60R 2300/8093

(57) ABSTRACT

A method for automating the operations of one or more vehicle-mounted cameras in a vehicle-mounted apparatus, obtains information of a geographic position of a vehicle and indications from a high-precision map as to conditions on the stretch of road being travelled by the vehicle. Information as to conditions of the road can include a width of the section of road being travelled by the vehicle. When the information of the road matches with a camera turn-on condition, such as for example the width of the road being less than a first predefined value, the vehicle-mounted camera is turned on. A system applying the method is also provided.

### FIELD

The subject matter herein generally relates to traffic safety, particularly to a method of automatically controlling a vehicle-mounted camera and a vehicle-mounted apparatus applying the method.

### BACKGROUND

Driving is risky when driving in blind areas, such as when passing through a narrow road or a road with obstacles. Vehicles with a camera or a radar sense a condition of a road for providing a driver-assistance function. The camera for monitoring the condition of the road must be manually turned on or turned off, which distracts attention of the driver while driving. The time to turn on a camera is hard to predict in a dark environment, and the distance monitored by the camera also is limited.

Thus, there is room for improvement in the art.

### BRIEF DESCRIPTION OF THE DRAWINGS

Implementations of the present disclosure will now be described, by way of example only, with reference to the attached figures.

FIG. 1 is a diagram illustrating an embodiment of a vehicle-mounted apparatus according to the present disclosure, the vehicle-mounted apparatus comprising a vehicle-mounted camera.

FIG. 2 is a flowchart illustrating a first embodiment of a method of automatically controlling a vehicle-mounted camera of FIG. 1 according to the present disclosure.

FIG. 3 is a flowchart illustrating a second embodiment of a method of automatically controlling the vehicle-mounted camera of FIG. 1 according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

As used in this application, the terms “environment,” “system,” “engine,” “module,” “component,” “architecture,” “interface,” “unit,” and the like refer to a computer-related entity or an entity related to an operational apparatus with one or more defined functionalities. The terms “environment,” “system,” “engine,” “module,” “component,” “architecture,” “interface,” and “unit” can be utilized interchangeably and can be generically referred to functional elements. Such entities may be either hardware, a combination of hardware and software, software, or software in execution. As an example, a module can be embodied in a process running on a processor, a processor, an object, an executable portion of software, a thread of execution, a program, and/or a computing device. As another example, both a software application executing on a computing device and the computing device can embody a module. As yet another example, one or more modules may reside within a process and/or thread of execution. A module may be localized on one computing device or distributed between two or more computing devices. As is disclosed herein, a module can be executed from various computer-readable non-transitory storage media having various data structures stored thereon. Modules can communicate via local and/or remote processes in accordance, for example, with a signal (either analog or digital) having one or more data packets (e.g., data from one component interacting with another component in a local system, distributed system, and/or across a network such as a wide area network with other systems via the signal).

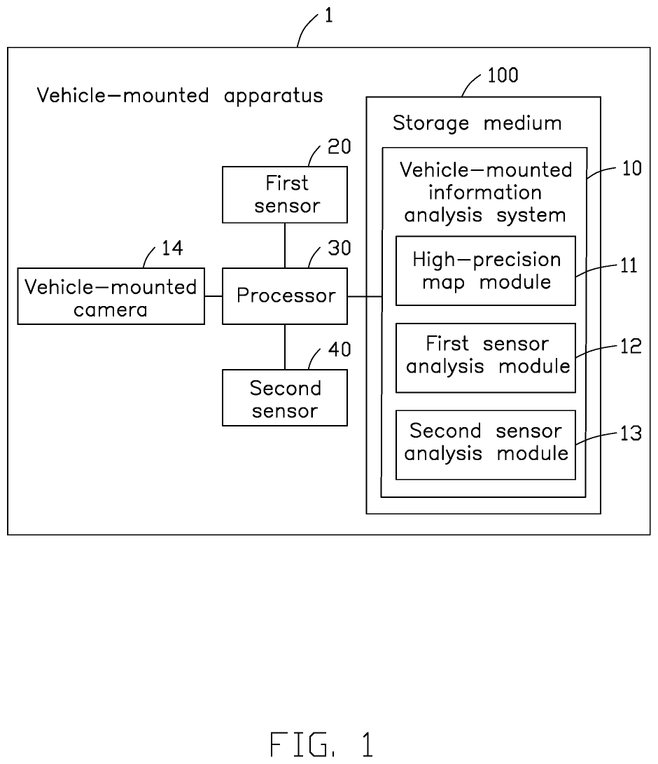

FIG. 1 shows a vehicle-mounted apparatus 1. The vehicle-mounted apparatus 1 includes a storage 100, a first sensor 20, a processor 30, a second sensor 40, and a vehicle-mounted camera 14. The storage medium 100 stores a vehicle-mounted information analysis system 10.

The first sensor 20, the second sensor 40, and the vehicle-mounted camera 14 are connected with the processor 30. The processor 30 is connected with the vehicle-mounted information analysis system 10. The information sensed by the first sensor 20, the second sensor 40, and the vehicle-mounted camera 14 is transmitted to the vehicle-mounted information analysis system 10 through the processor 30.

In some embodiments, the storage medium 100 is configured to store program codes and various data. The storage medium 100 can includes a read-only memory (ROM), a random access memory (RAM), a programmable read-only memory (PROM), an erasable programmable read-only memory (EPROM), a one time programmable read-only memory (OTPROM), an electrically erasable programmable read-only memory (EEPROM), a compact disc read-only memory (CD-ROM), an optical storage medium, a disk storage medium, a magnetic tape memory, or any other medium which can be used for carrying or storing data and can be accessed by a computer, but is not limited thereto.

In some embodiments, the processor 30 can be an integrated circuit, such as a single packaged integrated circuit, or may include a plurality of packaged integrated circuits having the same function or different functions. For example, the processor 30 may include one or more central processing units (CPUs), microprocessors, digital signal processors (DSPs), graphic processing units (GPUs), or a combination thereof. The processor 30 is a control unit of the vehicle-mounted apparatus 1, connects all parts of the vehicle-mounted apparatus 1 by using all types of interfaces and circuits, and executes functions of the vehicle-mounted apparatus 1 and processes data by running or executing the software program and/or modules stored in the storage medium 100 and calling up data stored in the storage medium 100.

The integrated units implemented in a form of software function modules can be stored in a computer readable storage medium. The software function modules as described above are stored in a storage medium 100, and the software function modules include instructions for causing a computer device (e.g., the computer device can be a personal computer, a server, or a network device, etc.) or the processor 30 to perform partial steps of methods of automatically controlling the vehicle-mounted camera in various embodiments of the present disclosure.

The storage medium 100 can store computer programs, such as program codes. The processor 30 can invoke the program codes stored in the storage medium 100 to executed related functions. In one embodiment, the storage medium 100 stores some instructions, which can be executed by the processor 30 to implement the method of automatically controlling the vehicle-mounted camera 14.

In some embodiments, the vehicle-mounted camera 14 can monitor an environment surrounding a vehicle by image-capture, and capture a real-time image of environment and display same, such as a central control display mounted in front of a driver's seat, which is an image of an area which a driver cannot see, for providing a driving assistance and improving a driving safety.

The vehicle-mounted information analysis system 10 can include a high-precision map module 11, a first sensor analysis module 12, and a second sensor analysis module 13.

In some embodiments, the high-precision map module 11 is configured to give information of a road in front of the vehicle and analyze conditions the road. The first sensor 20 and the second sensor 40 are configured to sense distances between the vehicle and one or more objects in the path or possible path of the vehicle (“adjacent object”).

In some embodiments, the high-precision map module 11 stores information of a real-time geographic position of a vehicle and information of the road related to the information of the geographic position of the vehicle.

In some embodiments, the first sensor 20 can be an independent camera beside the vehicle-mounted camera 14, and the first sensor 20 captures image of the external environment of the vehicle, which is transmitted to the first sensor analysis module 12 by the processor 30. The first sensor analysis module 12 detects the distance between the vehicle and the adjacent object using a computer-vision algorithm.

In some embodiments, the first sensor 20 also can be a camera able to switch automatically between an infrared radiation (IR) mode and a red, green, and blue three-primary-colors (RGB) mode. The first sensor 20 automatically switches between the IR mode and the RGB mode based on a light intensity of environment. When the light intensity of the environment is less than a light intensity predefined value, the first sensor 20 automatically switches to the IR mode, and the image which is output is a black-and-white image. When the light intensity of the environment is larger than the light intensity predefined value, the first sensor 20 automatically switches to the RGB mode, and the outputted image is a color image.

In some embodiments, the second sensor 40 can be a vehicle-mounted radar detector. The second sensor 40 detects information of external environment of the vehicle, which is transmitted to the second sensor analysis module 13 by the processor 30. The second sensor 40 detects the distance between the vehicle and the adjacent object based on a phase difference and a time difference.

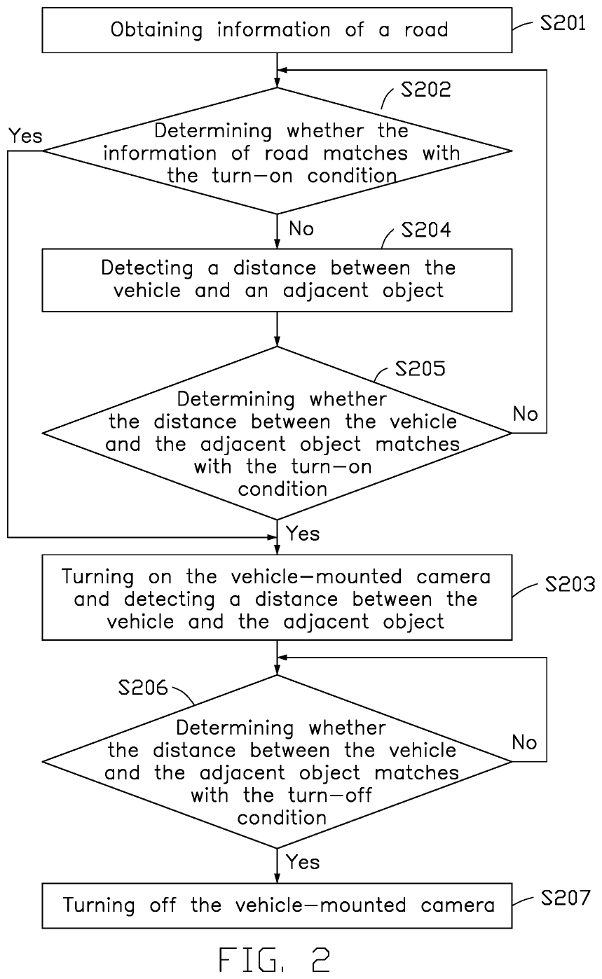

FIG. 2 is a flowchart of a first embodiment of a method of automatically controlling the vehicle-mounted camera. As shown in FIG. 2, the method of automatically controlling the vehicle-mounted camera is used in the system 10. The method includes the following steps, these steps may be re-ordered.

In block S201, information of a road is obtained, and the procedure goes to the block S202.

In some embodiments, the information of the road is obtained based on the real-time geographic position of the vehicle.

In block S202, determining whether the information of road matches with a condition required for turning on a camera (turn-on condition).

In some embodiments, the information of the road can include a width of the road. The turn-on condition can include the width of the road being less than a first predefined value. When the information of the road matches with the turn-on condition, the procedure goes to the block S203. When the information of the road does not match with the turn-on condition, the procedure goes to the block S204.

In block S203, the vehicle-mounted camera 14 turns on, the distance between the vehicle and the adjacent object is detected, and the procedure goes to the block S206.

In block S204, the distance between the vehicle and the adjacent object is detected, and the procedure goes to the block S205.

In block S205, determining whether the distance between the vehicle and the adjacent object matches with the turn-on condition.

In some embodiments, the turn-on condition further includes the distance being less than a second predefined value. When the distance matches with the turn-on condition, the procedure goes to the block S203. When the distance does not match with the turn-on condition, the procedure goes to the block S202.

In block S206, determining whether the distance between the vehicle and the adjacent object matches with a turn-off condition.

In some embodiments, the turn-off condition can include the distance becoming larger than the second predefined value. When the distance matches with the turn-off condition, the procedure goes to the block S207. When the distance does not match with the turn-off condition, the procedure goes to the block S206.

In block S207, the vehicle-mounted camera 14 turns off.

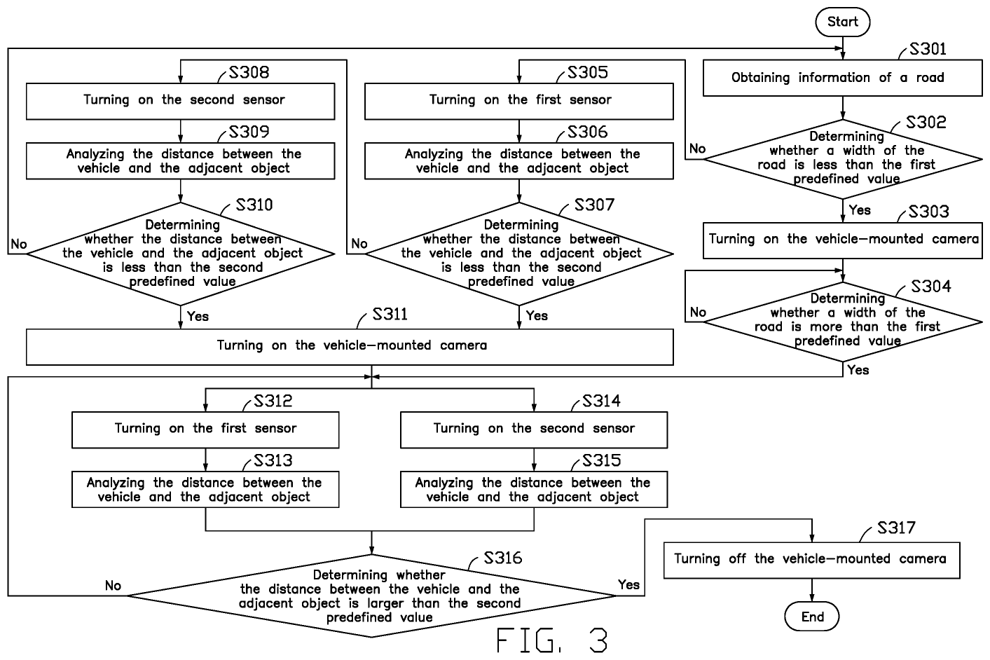

FIG. 3 is a flowchart of a second embodiment of a method of automatically controlling the vehicle-mounted camera. As shown in FIG. 3, the method of automatically controlling the vehicle-mounted camera is used in the system 10. The method includes the following steps, these steps may be re-ordered:

In block S301, information of a road is obtained.

In some embodiments, the high-precision map module 11 obtains the information of the road on which the vehicle is being driven. The information of the road includes a width of the road. The high-precision map module 11 stores information of a real-time geographic position of a vehicle and information of the road related to the information of the geographic position of the vehicle. The information of the road is obtained based on the real-time geographic position of the vehicle.

In block S302, determining whether a width of the road is less than the first predefined value.

In some embodiments, the high-precision map module 11 determines whether the width of the road is less than the first predefined value. When the width of the road is less than the first predefined value, the procedure goes to the block S303, and the vehicle-mounted camera 14 turns on. When the width of the road is larger than or equal to the first predefined value, the procedure goes to the block S305, and the first sensor 20 turns on.

In some embodiments, the first predefined value can be a predefined width of the road. When the width of the road is less than the first predefined value, the road being narrower, driving becomes more risky, and an assistance tool, such as the vehicle-mounted camera 14, needs to be applied for detecting the condition of the road for improving a safety of driving. When the width of the road is larger than the first predefined value, the vehicle can safely pass the road, and the assistance tool such as the first sensor 20, needs to be applied for detecting the condition of the road for improving the safety of driving.

In some embodiments, the high-precision map module 11 can also provide other conditions of the road. When the high-precision map module 11 indicates that the road is in a bad condition, such as the road being worked, repaired, or blocked by obstacles, driving becomes more risky, and an assistance tool such as the vehicle-mounted camera 14 needs to be applied for navigating the road for improving a safety of driving.

In block S303, the vehicle-mounted camera 14 turns on.

In some embodiments, when the vehicle-mounted camera 14 turns on, the vehicle-mounted camera 14 monitors the environment surrounding the vehicle and provides and displays a real-time image of environment, such as the central control display, for providing a driving assistance and improving a driving safety.

In block S304, determining whether the width of the road is larger than the first predefined value.

In some embodiments, the high-precision map module 11 can indicate the width of the road as being larger or smaller than the first predefined value. When the width of the road is larger than the first predefined value, the procedure goes to the block S312 and the block S314, and the first sensor 20 and the second sensor 40 turn on. When width of the road is less than or equal to the first predefined value, the procedure goes to the block S304.

In some embodiments, the first predefined value is a predefined width of the road. When the width of the road is larger than the first predefined value, the vehicle can safely pass the road, and the assistance tool, such as the first sensor 20 and the second sensor 40, needs to be applied for detecting the environment around the vehicle and improving the safety of driving.

In block S305, the first sensor 20 turns on.

In some embodiments, the first sensor 20 can be an independent camera beside the vehicle-mounted camera 14, and the first sensor 20 captures the image of external environment of the vehicle, which is transmitted to the first sensor analysis module 12 by the processor 30.

In some embodiments, the first sensor 20 also can be a camera automatically switching between the IR mode and the RGB mode. The first sensor 20 automatically switches between the IR mode and the RGB mode based on a light intensity of environment. When the light intensity of the environment is less than a light intensity predefined value, the first sensor 20 automatically switches to the IR mode, and the outputted image is a black-and-white image. When the light intensity of the environment is larger than the light intensity predefined value, the first sensor 20 automatically switches to the RGB mode, and the outputted image is a color image.

In some embodiments, the light intensity predefined value can be a predefined light intensity. When the light intensity of the environment is less than the light intensity predefined value, the vehicle is driving on a shadowed or unlit road which is dark, the vision of the driver is limited, and driving is more risky, and an assistance tool, such as the camera with the IR mode and the RGB mode, needs to be applied for detecting the condition of the road for improving a safety of driving.

In block S306, the distance between the vehicle and the adjacent object is analyzed.

In some embodiments, the first sensor analysis module 12 analyzes the image of the external environment besides the vehicle obtained by the first sensor 20 and determines the distance between the vehicle and the adjacent object.

In some embodiments, the first sensor analysis module 12 analyzes the distance between the vehicle and the adjacent object using a computer-vision algorithm.

In block S307, determining whether the width of the road is less than the second predefined value.

In some embodiments, the first sensor analysis module 12 determines whether the width of the road is less than the second predefined value. When the width of the road is less than the second predefined value, the procedure goes to the block S311, and the vehicle-mounted camera 14 turns on. When the width of the road is larger than or equal to the second predefined value, the procedure goes to the block S308, and the second sensor 40 turns on.

In some embodiments, the second predefined value can be a predefined distance between the vehicle and the adjacent object. When the distance between the vehicle and the adjacent object is less than the second predefined value, and the assistance tool, such as the vehicle-mounted camera 14, needs to be applied for detecting the environment around the vehicle and improving the safety of driving. When the distance between the vehicle and the adjacent object is larger than or equal to the second predefined value, the vehicle can safely pass and avoid the object, and the assistance tool, such as the second sensor 40, needs to be applied for detecting the environment around the vehicle and improving the safety of driving.

In block S308, the second sensor 40 turns on.

In some embodiments, the second sensor 40 can be a vehicle-mounted radar detector. The second sensor 40 detects information of external environment of the vehicle, which is transmitted to the second sensor analysis module 13 by the processor 30.

In block S309, the distance between the vehicle and the adjacent object is analyzed.

In some embodiments, the second sensor analysis module 13 analyzes the information of external environment of the vehicle obtained by the second sensor 40, and determines the distance between the vehicle and the adjacent object.

In some embodiments, the second sensor analysis module 13 determines the distance between the vehicle and the adjacent object based on a phase difference and a time difference.

In block S310, determining whether the width of the road is less than the second predefined value.

In some embodiments, the second sensor analysis module 13 determines whether the width of the road is less than the second predefined value. When the width of the road is less than the second predefined value, the procedure goes to the block S311, and the vehicle-mounted camera 14 turns on. When the width of the road is larger than or equal to the second predefined value, the procedure goes to the block S301.

In some embodiments, the second predefined value can be a predefined distance between the vehicle and the adjacent object. When the distance between the vehicle and the adjacent object is less than the second predefined value, and the assistance tool, such as the first sensor 20 and the second sensor 40, needs to be applied for detecting the environment around the vehicle and improving the safety of driving.

In block S311, the vehicle-mounted camera 14 turns on.

In some embodiments, when the vehicle-mounted camera 14 turns on, the environment of the vehicle can be monitored and the blind area (the area that the driver cannot see) of the driver also can be monitored for assisted driving and improving a safety of driving.

In block S312, the first sensor 20 turns on.

In some embodiments, the first sensor 20 can be an independent camera beside the vehicle-mounted camera 14, and the first sensor 20 captures the image of external environment, which is transmitted to the first sensor analysis module 12 by the processor 30.

In some embodiments, the first sensor 20 also can be a camera automatically switching between an IR mode and an RGB mode. The first sensor 20 automatically switches between the IR mode and the RGB mode based on a light intensity of environment. When the light intensity of the environment is less than a light intensity predefined value, the first sensor 20 automatically switches to the IR mode, and the outputted image is a black-and-white image. When the light intensity of the environment is larger than the light intensity predefined value, the first sensor 20 automatically switches to the RGB mode, and the outputted image is a color image.

In some embodiments, the light intensity predefined value can be a predefined light intensity. When the light intensity of the environment is less than the light intensity predefined value, the vehicle is driving on a dark road, and an assistance tool, such as the camera with the IR mode and the RGB mode, needs to be applied for detecting the condition of the road for improving a safety of driving.

In block S313, the distance between the vehicle and the adjacent object is analyzed.

In some embodiments, the first sensor analysis module 12 analyzes the image of the external environment beside the vehicle obtained by the first sensor 20 and determines the distance between the vehicle and the adjacent object.

In some embodiments, the first sensor analysis module 12 analyzes the distance between the vehicle and the adjacent object using a computer-vision algorithm.

In block S314, the second sensor 40 turns on.

In some embodiments, the second sensor 40 can be a vehicle-mounted radar detector. The second sensor 40 detects information of external environment of the vehicle, which is transmitted to the second sensor analysis module 13 by the processor 30.

In block S315, the distance between the vehicle and the adjacent object is analyzed.

In some embodiments, the second sensor analysis module 13 analyzes the information of external environment of the vehicle obtained by the second sensor 40, and determines the distance between the vehicle and the adjacent object.

In some embodiments, the second sensor analysis module 13 determines the distance between the vehicle and the adjacent object based on a phase difference and a time difference.

In some embodiments, after the block S304 and the block S311, the block S312 and the block S314 can be executed at the same time. Thus, the first sensor 20 and the second sensor 40 are used for determining whether the distance between the vehicle and the adjacent object is larger than the second predefined value. In some embodiments, only one of blocks S312 and S314 is executed, and only one of the first sensor 20 and the second sensor 40 is used for determining whether the distance between the vehicle and the adjacent object is larger than the second predefined value. In some embodiments, the distance between the vehicle and the adjacent object and the second predefined value can be determined by the first sensor 20, and then be determined and/or confirmed by the second sensor 40. Also, the distance between the vehicle and the adjacent object and the second predefined value can be determined by the second sensor 40, and then be further determined and/or confirmed by the first sensor 20.

In block S316, determining whether the distance between the vehicle and the adjacent object is larger than the second predefined value.

In some embodiments, the first sensor analysis module 12 and/or the second sensor analysis module 13 analyzes the distance between the vehicle and the adjacent object. When the distance between the vehicle and the adjacent object is larger than the second predefined value, the procedure goes to the block S17, and the vehicle-mounted camera 14 turns off. When the distance between the vehicle and the adjacent object is less than or equal to the second predefined value, the procedure goes to the block S312 and the block S314.

In some embodiments, the second predefined value can be a predefined distance between the vehicle and the adjacent object. When the distance between the vehicle and the adjacent object is larger than the second predefined value, the vehicle can safely pass and avoid the object.

In block S317, the vehicle-mounted camera 14 is turned off.

In some embodiments, when the width of the road is larger than the first predefined value, and the distance between the vehicle and the adjacent object is larger than the second predefined value, the assistance tool, such as the vehicle-mounted camera 14, can be turned off.

The above method of automatically controlling the vehicle-mounted camera 14 is used in a vehicle mounted apparatus. Information as to the condition of the road is obtained based on the high-precision map for automatically controlling the vehicle-mounted camera 14 to be turned on. By monitoring the environment of the vehicle, the vehicle-mounted camera 14 can be automatically turned on or turned off. The cameras are capable of switching between the IR mode and the RGB mode for different lighting conditions, and it is convenient for assisted driving.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of automatically controlling the vehicle-mounted camera used in a vehicle-mounted apparatus; the vehicle-mounted apparatus comprises a non-transitory storage medium with program codes, which when executed by a processor to implement the method; the method comprises:
obtaining information of a geographic position of a vehicle with the vehicle-mounted apparatus;
obtaining information of a road based on the information of the geographic position of the vehicle; the information of the road is stored in a high-precision map module; the information of the road comprises a width of the road;
determining whether the information of the road matches with a turn-on condition; the turn-on condition comprises the width of the road being less than a first predefined value; and
turning on the vehicle-mounted camera when the information of the road matches with a turn-on condition.

2. The method of claim 1, wherein the method further comprises:
detecting a distance between the vehicle and an adjacent object when the vehicle-mounted camera turns on;
determining whether the distance between the vehicle and the adjacent object matches with a turn-off condition; the turn-off condition comprises the distance between the vehicle and the adjacent object being larger than a second predefined value; and
turning off the vehicle-mounted camera when the distance between the vehicle and the adjacent object matches with the turn-off condition.

3. The method of claim 2, wherein the turn-on condition further comprises the distance between the vehicle and the adjacent object being larger than the second predefined value; the method further comprises:
turning on a first sensor for detecting the distance between the vehicle and the adjacent object, when the width of the road is larger than or equal to the first predefined value;
determining whether the distance between the vehicle and the adjacent object is less than the second predefined value; and
turning on the vehicle-mounted camera, when the first sensor detects that the distance between the vehicle and the adjacent object is less than the second predefined value.

4. The method of claim 3, wherein the method further comprises:
turning on a second sensor for detecting the distance between the vehicle and the adjacent object, when the width of the road is larger than or equal to the first predefined value and the first sensor detects that the distance between the vehicle and the adjacent object is larger than or equal to the second predefined value; and
turning on the vehicle-mounted camera, when the second sensor detects that the distance between the vehicle and the adjacent object is less than the second predefined value.

5. The method of claim 1, wherein the method further comprises:
turning on a first sensor for detecting the distance between the vehicle and the adjacent object, after the vehicle-mounted camera turns on; and
turning off the vehicle-mounted camera when the first sensor detects that the distance between the vehicle and the adjacent object is larger than a second predefined value.

6. The method of claim 5, wherein the method further comprises:
turning on a second sensor for detecting the distance between the vehicle and the adjacent object, after the vehicle-mounted camera turns on; and
turning off the vehicle-mounted camera, when the first sensor detects that the distance between the vehicle and the adjacent object is larger than the second predefined value.

7. The method of claim 5, wherein the first sensor is an independent camera besides the vehicle-mounted camera; the first sensor captures images of external environment of the vehicle, and detects the distance between the vehicle and the adjacent object using a computer-vision algorithm.

8. The method of claim 5, wherein the first sensor is an independent camera besides the vehicle-mounted camera; the first sensor automatically switches between an infrared radiation (IR) mode and a red, green, blue three-primary colors (RGB) mode based on a light intensity of environment; when the light intensity of the environment is less than a light intensity predefined value, the first sensor automatically switches to the IR mode; when the light intensity of the environment is larger than the light intensity predefined value, the first sensor automatically switches to the RGB mode.

9. The method of claim 6, wherein the second sensor is a vehicle-mounted radar detector; the second sensor detects the distance between the vehicle and the adjacent object based on a phase difference and a time difference.

10. A vehicle-mounted apparatus comprises:
a vehicle-mounted camera, configured to capture a real-time environment image surrounding a vehicle;
a storage medium, configured to store program codes and a high-precision map module; the high-precision map module stores information of a real-time geographic position of the vehicle and information of the road related to the information of the geographic position of the vehicle;
sensors, configured to detect a distance between the vehicle and an adjacent object; and
a processor, configured to execute the program codes stored in the storage medium to implement the following steps:
obtaining information of a geographic position of a vehicle with the vehicle-mounted apparatus;
obtaining information of a road based on the information of the geographic position of the vehicle; the information of the road is stored in a high-precision map module; the information of the road comprises a width of the road;
determining whether the information of the road matches with a turn-on condition; the turn-on condition comprises the width of the road being less than a first predefined value; and
turning on the vehicle-mounted camera when the information of the road matches with a turn-on condition.

11. The vehicle-mounted apparatus of claim 10, wherein the processor further:
detecting a distance between the vehicle and an adjacent object when the vehicle-mounted camera turns on;
determining whether the distance between the vehicle and the adjacent object matches with a turn-off condition; the turn-off condition comprises the distance between the vehicle and the adjacent object being larger than a second predefined value; and
turning off the vehicle-mounted camera when the distance between the vehicle and the adjacent object matches with the turn-off condition.

12. The vehicle-mounted apparatus of claim 11, wherein the turn-on condition further comprises the distance between the vehicle and the adjacent object being larger than the second predefined value; the processor further:
turning on a first sensor for detecting the distance between the vehicle and the adjacent object, when the width of the road is larger than or equal to the first predefined value;
determining whether the distance between the vehicle and the adjacent object is less than the second predefined value; and
turning on the vehicle-mounted camera, when the first sensor detects that the distance between the vehicle and the adjacent object is less than the second predefined value.

13. The vehicle-mounted apparatus of claim 12, wherein the processor further:
turning on a second sensor for detecting the distance between the vehicle and the adjacent object, when the width of the road is larger than or equal to the first predefined value and the first sensor detects that the distance between the vehicle and the adjacent object is larger than or equal to the second predefined value; and
turning on the vehicle-mounted camera, when the second sensor detects that the distance between the vehicle and the adjacent object is less than the second predefined value.

14. The vehicle-mounted apparatus of claim 10, wherein the processor further:
turning on a first sensor for detecting the distance between the vehicle and the adjacent object, after the vehicle-mounted camera turns on; and
turning off the vehicle-mounted camera when the first sensor detects that the distance between the vehicle and the adjacent object is larger than a second predefined value.

15. The vehicle-mounted apparatus of claim 14, wherein the processor further:
turning on a second sensor for detecting the distance between the vehicle and the adjacent object, after the vehicle-mounted camera turns on; and
turning off the vehicle-mounted camera, when the first sensor detects that the distance between the vehicle and the adjacent object is larger than the second predefined value.

16. The vehicle-mounted apparatus of claim 14, wherein the first sensor is an independent camera besides the vehicle-mounted camera; the first sensor captures images of external environment of the vehicle, and detects the distance between the vehicle and the adjacent object using a computer-vision algorithm.

17. The vehicle-mounted apparatus of claim 14, wherein the first sensor is an independent camera besides the vehicle-mounted camera; the first sensor automatically switches between an infrared radiation (IR) mode and a red, green, blue three-primary colors (RGB) mode based on a light intensity of environment; when the light intensity of the environment is less than a light intensity predefined value, the first sensor automatically switches to the IR mode; when the light intensity of the environment is larger than the light intensity predefined value, the first sensor automatically switches to the RGB mode.

18. The vehicle-mounted apparatus of claim 14, wherein the second sensor is a vehicle-mounted radar detector; the second sensor detects the distance between the vehicle and the adjacent object based on a phase difference and a time difference.
